(19) United States
(12) Patent Application Publication
(10) Pub. No.: US 2024/0070295 A1
(43) Pub. Date: Feb. 29, 2024

(54) BROWSER EXTENSION TO DETECT AND REMEDIATE SENSITIVE DATA

(71) Applicant: Capital One Services, LLC, McLean, VA (US)

(72) Inventors: Jennifer Kwok, Brooklyn, NY (US); Max Miracolo, Brooklyn, NY (US); Salik Shah, Washington, DC (US); Erin Babinsky, Arlington, VA (US); John Martin, Brooklyn, NY (US); Nima Chitsazan, Ridgefield, NJ (US); Mia Rodriguez, Broomfield, CO (US); Andrea Montealegre, Arlington, VA (US); Seth Wilton Cottle, Reston, VA (US); Ignacio Espino, Arlington, VA (US); Zviad Aznaurashvili, Reston, VA (US); Dwipam Katariya, McClean, VA (US); Gaurang J. Bhatt, Herndon, VA (US)

(21) Appl. No.: 17/893,491

(22) Filed: Aug. 23, 2022

(51) Int. Cl. G06F 21/60; G06F 9/445; G06F 9/451; G06F 16/903

(52) U.S. Cl. CPC G06F 21/602; G06F 9/44526; G06F 9/453; G06F 16/90344

(57) ABSTRACT

Disclosed embodiments pertain to protecting sensitive information. A browser extension associated with a web browser can detect a user entering information associated with the user into an electronic form. The browser extension can monitor the user entering sensitive information into the electronic form and detect that the user has entered sensitive information incorrectly. In response, the browser extension can provide a warning to the user that sensitive information has been incorrectly entered. Instructions can be displayed to a user on how incorrectly entered sensitive information is to be corrected. The incorrectly entered sensitive information is corrected based on a response from the user before the sensitive information propagates beyond the electronic form.

### BACKGROUND

Customer service representatives/agents and customers (e.g., users) may accidentally enter sensitive information (e.g., sensitive information) such as personally identifiable information (PII) into wrong form fields or other wrong locations in electronic documents. For example, customers and agents have been found prone to enter social security numbers (SSNs) and credit card numbers into incorrect portions including the note fields of electronic documents. Customers have also accidentally filled in their user names with their SSN or credit card number. Customers also incorrectly enter sensitive information such as PII in a number of other unconventional ways. When entered incorrectly, this unmasked sensitive information may end up being transmitted without proper encryption and may not be properly encrypted and stored. This may violate federal and international regulations requiring sensitive information and PII to be properly transmitted and stored with adequate safety measures. When an organization violates one or more regulations, that organization may suffer from a damaged reputation. If an organization is known by the public to violate regulations regarding proper handling of sensitive information and PII, that organization may suffer from public trust and eventually lose economically from the loss of business from a reduced customer base.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

According to one aspect, disclosed embodiments may include a system that comprises a processor coupled to a memory that includes instructions that, when executed by the processor, cause the processor to detect, with a browser extension of a web browser, a user entering information associated with the user into an electronic form, monitor, with the browser extension, the user entering sensitive information into the electronic form, detect that the user incorrectly entered the sensitive information. Further, the processor may be configured to provide, through the browser extension, a warning to the user that sensitive information has been entered incorrectly, display instructions on how to correct the incorrectly entered sensitive data, and correct the incorrectly entered sensitive information based on a response from the user before the sensitive information propagates beyond the electronic form. The instructions further cause the processor to invoke a machine learning model to detect that the user has incorrectly entered the sensitive information. Further, the instructions may cause the processor to detect that the user incorrectly entered sensitive information when a likelihood predicted by the machine learning model satisfies a predetermined threshold. In one instance, instructions may further cause the processor to invoke the machine learning model to detect that the user has incorrectly entered the sensitive information base on context surrounding the sensitive information. In one scenario, the context is included in a free-form notes field. The instructions may also cause the processor to detect that the user has incorrectly entered the sensitive information based on pattern matching with a regular expression. Further, the instructions may cause the processor to prevent the user, by the browser extension, from proceeding to a next electronic form screen until the incorrectly entered sensitive information has been corrected. Furthermore, the instructions may cause the processor to at least one of remove, encrypt, or obfuscate the incorrectly entered sensitive data to correct the incorrectly entered sensitive data. In one embodiment, the user may be a telephone center agent.

In accordance with another aspect, disclosed embodiments may include a method comprising executing, on a processor, instructions that cause the processor to perform operations protecting sensitive information. The operations include detecting, with a browser extension associated with a web browser, a user entering information associated with the user into an electronic form, monitoring, with the browser extension, the user entering sensitive information into the electronic form, detecting that the user incorrectly entered the sensitive information, providing, through the browser extension, a warning to the user that the sensitive information has been incorrectly entered, displaying instructions on how to correct the incorrectly entered sensitive information, and correcting the incorrectly entered sensitive information based on a response from the user before the sensitive information propagates beyond the electronic form. The operations may further comprise invoking a machine learning model to detect if the user is entering the sensitive information incorrectly. Further, the operations may provide a mechanism to receive feedback from a user regarding performance of the machine learning model. The operations may further comprise detecting the user incorrectly entered sensitive information with one or more regular expressions. The operations may also further comprise preventing the user, by the browser extension, from proceeding to a next electronic form screen until the incorrectly entered sensitive information has been corrected. Furthermore, the operations may comprise displaying instructions on how the incorrectly entered sensitive information is to be corrected in a pop-up text box. In one instance, correcting may further comprise at least one of removing, encrypting, or obfuscating the sensitive information.

According to yet another aspect, disclosed embodiments may include a computer-implemented method. The method comprises detecting, with a browser extension associated with a web browser, a user entering data into an electronic form, predicting, with a machine learning model, improper entry of sensitive data into an electronic form field, providing, with the browser extension, a warning to the user that sensitive data has been improperly entered, displaying instructions on how to address the improperly entered sensitive data, and correcting the improperly entered sensitive data based on a response from the user before the sensitive data propagates beyond the electronic form. The method may further comprise predicting the improper entry of the sensitive data when a confidence score provided by the machine learning model satisfies a predetermined threshold. Further, the method may comprise predicting the improper entry of the sensitive data based on context information surrounding the sensitive data. Additionally, correcting may further comprise at least one of removing, encrypting, or obfuscating the sensitive data.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

The accompanying drawings, which are incorporated in and constitute a part of the specification, illustrate various example methods and configurations of various aspects of the claimed subject matter. It will be appreciated that the illustrated element boundaries (e.g., boxes, groups of boxes, or other shapes) in the figures represent one example of the boundaries. It is appreciated that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an overview of an example implementation.

FIG. 2 is a block diagram of a sensitive information protection system.

FIG. 3 is a block diagram of another example sensitive information protection system.

FIG. 4 is a block diagram of an example machine learning model.

FIG. 5 is a block diagram of another example sensitive information protection system.

FIG. 6 is a flow chart diagram of a method of sensitive information protection.

FIG. 7 is a flow chart diagram of another method for protecting sensitive information.

FIG. 8 is a flow chart diagram of another method for protecting sensitive information.

FIG. 9 is a block diagram illustrating a suitable operating environment for aspects of the subject disclosure.

### DETAILED DESCRIPTION

Improperly captured highly sensitive human data enter databases and other insecure locations each year. Improperly stored highly sensitive human data comes from multiple origin sources (e.g., agents, customers, engineers, and third parties). Preferably, it is desirable to capture where sensitive information originates to prevent sensitive information from entering a computer system/network as early as possible to allow for easier remediation of incorrectly entered sensitive information as early as possible. Preventing the sensitive data from entering a computer system/network at its source may prevent later remediation of incorrectly entered sensitive information.

Browser extensions customized to detect incorrectly entered sensitive information at its source, in real-time, may prevent the later need to remediate incorrectly entered sensitive information. In one example configuration, browser extensions may use a machine learning model on the edge to detect certain types of sensitive data/information and alert the end-user for review/remediation. This solution may feature real-time and automated prevention of transmission of incorrectly entered sensitive information from spreading further downstream. The machine learning model considers context in free-form notes (i.e., unstructured data), reducing false positives that could happen if using detection through regular expression rules/logic. The user interface empowers the user to remediate and move forward responsibly. In some instances, it may provide an opportunity for the end user to also provide feedback if the detected finding is inaccurate or accurate. This federated machine learning model helps improve the model's accuracy without having any sensitive information flow through the wire. The user interface may be a coaching mechanism that influences behavior and prevents future mistakes.

One example method for protecting sensitive information includes executing on a processor instructions that cause the processor to perform operations associated with protecting sensitive information. The operations include detecting, with a browser extension associated with a web browser, a user entering information associated with the user into an electronic form. The method monitors, with the browser extension, the user entering sensitive information into the electronic form. The method detects that the user has entered sensitive information incorrectly. A warning is provided, via the browser extension, to the user that sensitive information has been incorrectly entered. Instructions are displayed in real-time to a user on how incorrectly entered sensitive information is to be corrected. The incorrectly entered sensitive information is corrected based on a response from the user before the sensitive information propagates beyond the electronic form.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

“Processor” and “Logic”, as used herein, includes but are not limited to hardware, firmware, software, and/or combinations of each to perform a function(s) or an action(s), and/or to cause a function or action from another logic, method, and/or system to be performed. For example, based on a desired application or need, the logic and/or the processor may include a software-controlled microprocessor, discrete logic, an application specific integrated circuit (ASIC), a programmed logic device, a memory device containing instructions, or the like. The logic and/or the processor may include one or more physical gates, combinations of gates, or other circuit components. The logic and/or the processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

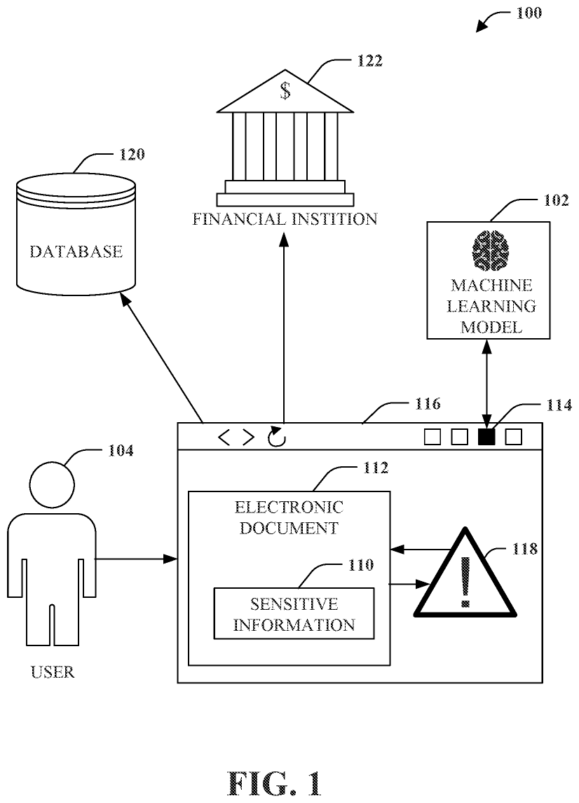

Referring initially to FIG. 1, a high-level overview of an example implementation of a system 100 for detecting, in real-time, sensitive information 110 (e.g., sensitive data) incorrectly entered in an electronic document 112 and requesting that the incorrectly entered sensitive information 110 be corrected. The system 100 includes aspects for leveraging user input in browser 116 to inform a machine learning model 102 for reducing false positives. A browser extension 114 uses a machine learning model 102 on the edge to detect certain types of sensitive information 110 and alert a user 104 for review/remediation. The system 100 features real-time correction of incorrectly entered sensitive information and the automated prevention of transmission of the incorrectly entered sensitive information 110 from spreading further downstream.

In a bit more detail, the user 104 enters data that may be sensitive information 110 into an electronic document 112 that may be displayed by a browser 116. As the data is being entered into the electronic document 112, the browser extension 114 engages the machine learning model 102 to monitor the input of data to detect if sensitive information 110 is being entered incorrectly. To detect if sensitive information 110 is being entered incorrectly, the machine learning model 102 may consider a context in free-form notes (e.g., unstructured data) by detecting incorrectly entered sensitive information 110 using regular expression rules/logic.

When the machine learning model 102 detects sensitive information possibly being entered incorrectly, the browser extension 114 may display, in real-time, a warning 118 to the user 104 to indicate sensitive information 110 may be incorrectly entered. In some instances, the browser extension 114 may prevent the user 104 from entering any further data into the electronic document 112 until the incorrectly entered sensitive information 110 is remedied. In some configurations, the browser extension 114 may allow the user 104 to override the warning 118 by indicating that there is not any sensitive information incorrectly entered. The machine learning model 102 may be trained with this information in this case.

Once all the data, including sensitive information, has been entered into the electronic document 112 without any deficiencies, the browser extension 114 may allow the electronic form to be sent from the browser 116 to other location such as a database 120 or a financial institution 122, a business, a school, and the like. This federated machine learning model helps improve the model's accuracy without having any sensitive information flow through the wire. The user interface can be a coaching mechanism that influences behavior and prevents future mistakes. Catching sensitive information that is incorrectly entered in this way and having the sensitive information re-entered properly before it is stored and/or encrypted avoids violating national and international regulations protecting the safe handling of sensitive information. It is much better to correct and find sensitive information early and properly obscure the sensitive information early rather than after it makes its way into a data system.

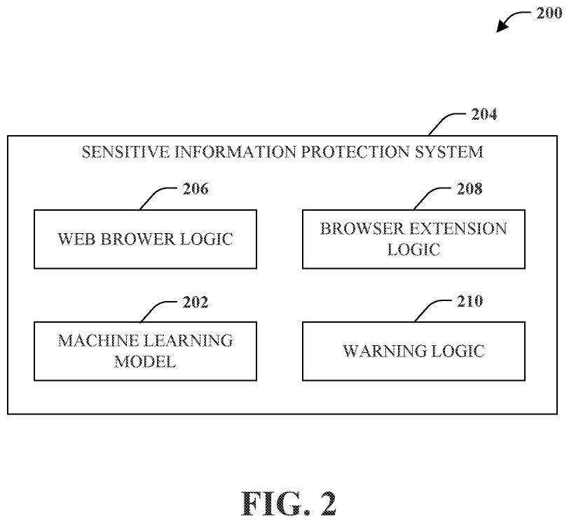

Turning attention to FIG. 2, an example system 200 that protects sensitive information is illustrated. The example system 200 uses a browser extension with a machine learning model 202 that may be on the edge to detect certain types of sensitive data/information and alert the end-user for review/remediation. This example system 200 may feature real-time and automated prevention of transmission of incorrectly entered sensitive information from spreading further downstream from where sensitive information is entered into an electronic form. The example system 200 includes an example sensitive information protection system 204. The example sensitive information protection system 204 includes a machine learning model 202, a web browser logic 206, a browser extension logic 208, and a warning logic 210.

The web browser logic 206 provides a way for a user to access a web browser and have it displayed on a display device of an electronic device, for example, the device on which the sensitive information protection system 204 is implemented. The web browser logic 206 may further allow the user to access and display a web-based electronic document through the web browser. The web browser logic 206 may further allow the user to enter data including sensitive information into the electronic document.

Once the electronic document is displayed, the browser extension logic 208 activates to monitor data and sensitive information entered into the electronic document. In some instances, the browser extension logic 208 activates to monitor data and sensitive information entered into the electronic document. In other configurations, the browser extension logic 208 activates the machine learning model 202 to monitor data and sensitive information entered into the electronic document. If the browser extension logic 208 detects sensitive information being entered into the electronic document as the browser extension logic 208 is monitoring the electronic document, the browser extension logic 208 may provide the sensitive information and associated data to the machine learning model 202 to be sure the sensitive information is entered correctly entered into the electronic form.

The machine learning model 202 will check the sensitive information and its associated data (e.g., data on both sides of the sensitive information) to be sure the sensitive information is entered correctly. Other data associated with the sensitive information may include whether the sensitive information was entered by a user or a customer agent, behavioral biometric data of the user or agent, user data, agent data, and/or digital interaction data. The machine learning model 202 uses this information and performs a regular expression analysis of the sensitive information to determine if the sensitive information was entered correctly. In one example, the machine learning model 202 may consider context in free-form notes (e.g., unstructured data), reducing false positives that could happen if using detection through regular expression rules/logic.

In general, regular expressions generally use a compact notation to describe the set of strings that make up a regular language. Regular expressions are a precise way of specifying a pattern that applies to all members of the set and may be particularly useful when the set has many elements. Regular expressions work on the principle of providing characters that need to be matched. For example, the regular expression cat would match the consecutive characters c-a-t. Regular expressions can be useful to programmers and can be used for a variety of tasks: (1) searching for strings, e.g., the word ‘needle’ in a large document about haystacks, (2) implementing a “find and replace” function that locates a group of characters and replaces them with another group, and (3) validating user input, e.g., email addresses or passwords. A regular language can be defined as any language that can be expressed with a regular expression.

When the machine learning model 202 detects that sensitive information has been entered incorrectly, that information is passed to the warning logic 210. The warning logic 210 uses this information to request that the user (or agent) rectify the sensitive information that was incorrectly entered. The request may be in the form of a text box that pops up near where the sensitive information was incorrectly entered, explaining why the information was incorrectly entered and how to correctly re-enter that sensitive information. Alternatively, the warning logic 210 may invoke a chat box to pop up and guide the user on how to correctly enter the sensitive information. In other alternatives, the warning logic 210 may cause lights to flash, or objects within the electronic document may flash or change colors to indicate sensitive information has been incorrectly entered. Additionally, the warning logic 210 may cause activation of audible sounds such as alarms, beeping noises, or other sounds when sensitive information has been incorrectly entered. In some configurations, the warning logic 210 may prevent the entering of any further data until a current sensitive information entry is corrected.

In some configurations, the warning logic 210 may provide a way for the user or customer agent to override a machine learning model determination that sensitive information has been improperly entered into an electronic form. When this occurs, this override information may be provided to the machine learning model 202 so that the machine learning model 202 may be trained on this information to allow the machine learning model to make better future predictions of sensitive information being improperly entered. Providing feedback leverages human input in the browser to inform the machine learning model 202 for reducing false positives in the future.

A browser with the browser extension logic 208 empowers the user to remediate and move forward responsibly and provides an opportunity for the end user to provide feedback if the detected finding is inaccurate. This federated machine learning model helps improve the accuracy of the model without having unmasked sensitive information flow external from the example sensitive information protection system 204. The browser extension logic 208 and machine learning model 202 combination may provide a coaching mechanism that influences behavior and prevents future mistakes.

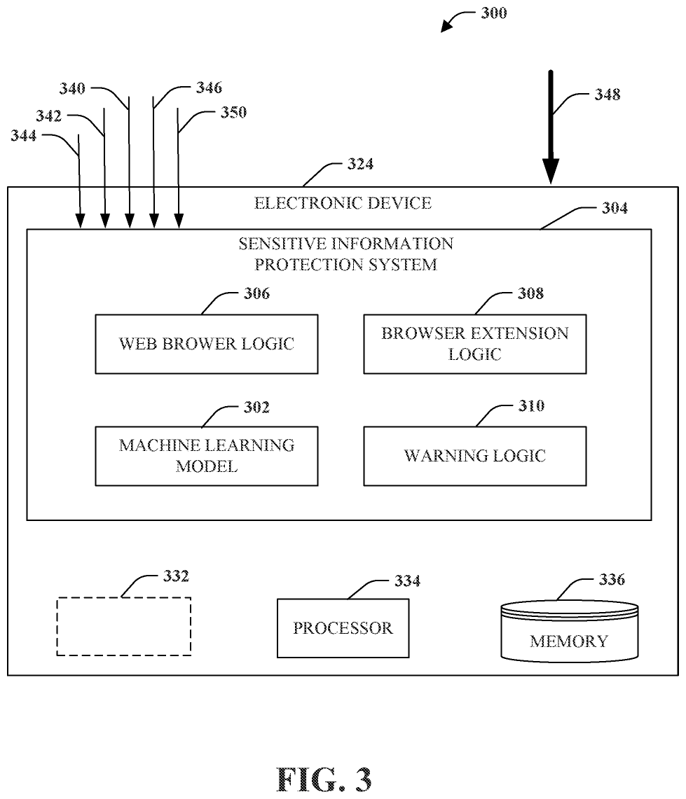

FIG. 3 illustrates an example sensitive information protection system 300. The example system 300 includes an electronic device 324 and a sensitive information protection system 304 that protect sensitive information 332. Sensitive information 332 is related to data that may identify a person, such as personally identifiable information (PII). PII may include a person's name, birth date, social security number, credit card number, driver's license number, and the like. The electronic device 324 includes an electronic device processor 334, a memory 336, and the sensitive information protection system 304. The sensitive information protection system 304 includes a web browser logic 306, a machine learning model 302, a browser extension logic 308, and a warning logic 310.

The sensitive information protection system 304 or portions of the sensitive information protection system 304 may be implemented with solid state devices such as transistors to create processors that implement functions that may be executed in silicon or other materials. Furthermore, the electronic device processor 334 may be implemented with general-purpose processors, digital signal processors (DSPs), application-specific integrated circuits (ASICs), field-programmable gate arrays (FPGAs), or other programmable logic devices, discrete gates or transistor logics, discrete hardware components, or any combination thereof designed to perform the functions described herein. A general-purpose processor may be a microprocessor, but in the alternative, the processor may be any processor, controller, microcontroller, or state machine. The electronic device processor 334 may also be implemented as a combination of computing devices, for example, a combination of a DSP and a microprocessor, a plurality of microprocessors, multi-core processors, one or more microprocessors in conjunction with a DSP core, or any other such configuration as understood by those of ordinary skill in the art.

A primary input to the machine learning model 302 is the sensitive information and other data adjacent to the sensitive information 348, which may or may not contain sensitive information. This information is input into the sensitive information protection system 304 and machine learning model 302. In other configurations, the sensitive information protection system 304 and the machine learning model 302 may also receive, associated with the sensitive information, the biometric behavior data 340, user data 342 (e.g., customer data), an agent data 344, metadata 346, and/or an IP address 350. These inputs 340, 342, 344, 346, and 350 may be input to the machine learning model 302. These inputs are useful to the machine learning model 302 for detecting sensitive information. An originating source internet protocol (IP) address 350 or a device type data when the data was captured may also be used by the machine learning model 302 to determine if sensitive information is present in the dataset.

In general, and similar to what was mentioned above, the sensitive information protection system 304 uses the web browser logic 306 to provide for a web browser to be displayed on a display device of the electronic device 324. The web browser logic 306 may further allow the user to access and display a web-based electronic document through the web browser. The web browser logic 306 may further provide for the user to enter data including sensitive information into the electronic document.

Once the electronic document is displayed, the browser extension logic 308 activates to monitor data including sensitive information being entered into the electronic document. In some instances, the browser extension logic 308 activates to monitor data including sensitive information being entered into the electronic document. In other instances, the browser extension logic 308 activates the machine learning model 302 to monitor data including sensitive information being entered into the electronic document. If the browser extension logic 308 detects sensitive information being entered into the electronic document as the browser extension logic 308 is monitoring the electronic document, the browser extension logic 308 may provide the sensitive information and associated data to the machine learning model 302 to be sure the sensitive information is entered correctly into the electronic form. In another configuration, the machine learning model 302 will directly monitor data on the sensitive information being entered into the web browser.

The machine learning model 302 checks the sensitive information and its associated data (e.g., data on both sides of the sensitive information) to be sure the sensitive information is entered correctly. Other data associated with the sensitive information may be whether the sensitive information was entered by a user or a customer agent, behavioral biometric data of the user or agent, user data, agent data, and/or digital interaction data. The machine learning model 302 uses this information and performs a regular expression analysis of the sensitive information to determine if the sensitive information was entered correctly. In one example, the machine learning model 302 may consider, in real-time, context in free-form notes (i.e., unstructured data), reducing false positives that could happen if using detection through regular expression rules/logic.

When the machine learning model 302 detects that sensitive information has been entered incorrectly, that information is passed to the warning logic 310. The warning logic 310 uses this information to request that the user (or agent) rectify the sensitive information that was incorrectly entered. The request may be a text box that pops up near where the sensitive information was incorrectly entered, explaining why the information is incorrectly entered and how to correctly re-enter that sensitive information. Alternatively, the warning logic 310 may invoke a chat box to pop up and guide the user on how to correctly enter the sensitive information. In other alternatives, the warning logic 310 may cause lights to flash, or objects within the electronic document may flash or change colors to indicate sensitive information has been incorrectly entered. Additionally, the warning logic 310 may cause audible sounds such as an alarm or beeping noises to be activated or other sounds to be activated when sensitive information has been incorrectly entered. In some configurations, the warning logic 310 may prevent entering any further data until a current sensitive information entry is corrected.

In some configurations, the warning logic 310 may provide a way for the user or customer agent to override a machine learning model 302 determination that sensitive information has been improperly entered into an electronic form. When this occurs, this override information may be provided to the machine learning model 302 so that the machine learning model 302 may be trained on this information to allow the machine learning model 302 to make better future predictions of sensitive information being improperly entered. Providing feedback leverages human input in the browser to inform the machine learning model 302 for reducing false positives in the future.

In another configuration, the machine learning model 302 is operable to analyze the sensitive information and compute a risk score (e.g., confidence value) and determine if the risk score crosses a threshold level (e.g., exceeds a threshold level). The risk score is a value that indicates the likelihood that an item on a form, website, or the like, was sensitive information that was entered incorrectly. In other words, the risk score is a value that captures the probability that sensitive information was entered incorrectly. For example, the machine learning model 302 can employ one or more rules to compute the risk score.

Various portions of the disclosed systems above, as mentioned, and methods below can include or employ artificial intelligence or knowledge or rule-based components, sub-components, processes, means, methodologies, or mechanisms (e.g., support vector machines, neural networks, expert systems, Bayesian belief networks, fuzzy logic, data fusion engines, classifiers). Such components, among others, can automate certain mechanisms or processes performed thereby, making portions of the systems and methods more adaptive as well as efficient and intelligent. By way of example, and not limitation, the machine learning model 302 can employ such mechanisms to automatically determine a risk score (e.g., confidence value) that is associated with the risk of sensitive information being incorrectly entered into an electronic form or if the sensitive information should have been entered into a form at all.

In another configuration, customer agents may type notes that may be reviewed by subject matter experts or “data stewards”. The machine learning model 302 may detect whether a customer agent is typing sensitive information into a form field. Certain electronic form fields may be specifically checked where errors are often known to occur. For example, a field for entering an SSN may not be checked because the format of the field prevents errors. However, subject line and free form note fields are checked by data stewards.

In one example configuration, the electronic device 324 includes the electronic device processor 334 as well as memory 336, respectively. The electronic device processor 334 may be implemented with solid state devices such as transistors to create processors that implement functions that may be executed in silicon or other materials. Furthermore, the electronic device processor 334 may be implemented with general-purpose processors, digital signal processors (DSPs), application-specific integrated circuits (ASICs), field-programmable gate arrays (FPGAs), or other programmable logic devices, discrete gates or transistor logics, discrete hardware components, or any combination thereof designed to perform the functions described herein. A general-purpose processor may be a microprocessor, but in the alternative, the processor may be any processor, controller, microcontroller, or state machine. The electronic device processor 334 may also be implemented as a combination of computing devices, for example, a combination of a DSP and a microprocessor, a plurality of microprocessors, multi-core processors, one or more microprocessors in conjunction with a DSP core, or any other such configuration as understood by those of ordinary skill in the art.

The storage device or memory 336 can be any suitable device capable of storing and permitting the retrieval of data. In one aspect, the storage device or memory 336 is capable of storing data representing sensitive information and other data entered into an electronic form. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The memory 336 can correspond to a persistent data structure (e.g., tables) accessible by the machine learning model 302. As such, a computing device is configured to be a special-purpose device or appliance that implements the sensitive information protection system 304. The memory 336 can be implemented in silicon or other hardware components so that the hardware and/or software can implement functionality of the data store as described herein.

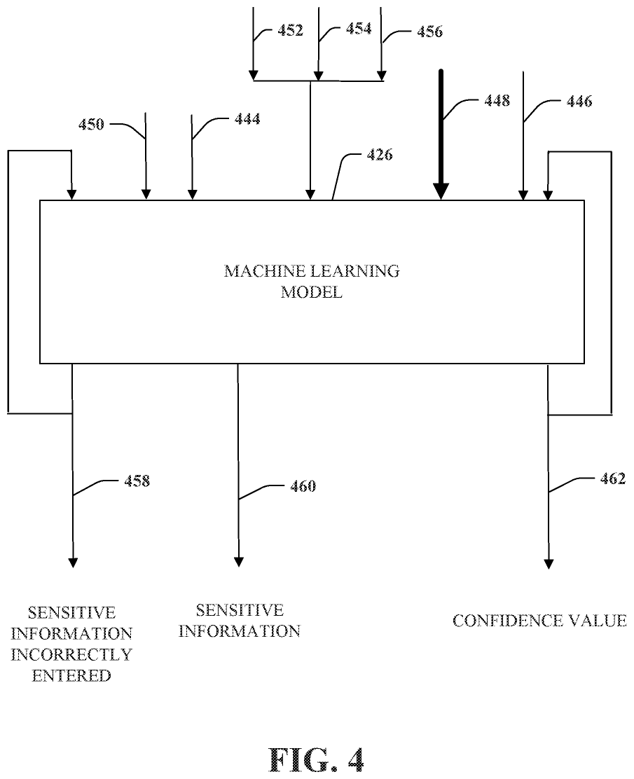

FIG. 4 depicts the machine learning model 426 in accordance with an example embodiment. The machine learning model 426 monitors the entry of sensitive information as it is being entered into an electronic form. The machine learning model 426 may also assign a confidence value 462 (e.g., risk score) to the found sensitive information. In another possible instance, the machine learning model 426 is used to prevent end computer system users from accidentally incorrectly inputting and submitting sensitive information. This helps to prevent users from incorrectly entering sensitive information at the source in real-time and eliminates the requirement of cleaning up incorrectly entered sensitive information after the sensitive information has already been committed to a form, stored in memory, or the like.

Data and sensitive data being entered into an electronic form 448 that the machine learning model 426 is processing is a primary input of the machine learning model. User data 342 (e.g., customer data) and biometric behavior data 450 are also input to the machine learning model 426. Instead of looking at a profile of the person, biometric behavior captures a profile of the person's behavior profile. Non-biometric behavior data are also a primary input into the machine learning model 426. In general, non-biometric behavior data captures a profile unique to an individual. Non-biometric behavior data may include three types of data. This data includes user information 452 (or customer information), agent information 454, and digital interaction data 456. An internet protocol (IP) address 444 is also input to the machine learning model 426, with the IP address 444 being a device type data when the data was captured that may also be used by the machine learning model 426 to determine if sensitive information is present and being input into an electronic form. Data steward feedback 446 is also input to the machine learning model 426. As mentioned above, data stewards are humans that check labeled sensitive information with a low confidence value/level and correct and/or provide other feedback to the machine learning model 426.

The machine learning model 426 is trained on the data discussed above for detecting sensitive information and produces a confidence value 462 associated with found sensitive information. The machine learning model 426 may output what it considers sensitive information 460 that may need to be redacted as indicated by the sensitive information incorrectly entered signal 458. The machine learning model 426 also outputs a confidence value/risk score that indicates how confident the machine learning model 426 is that the sensitive information 460 is indeed sensitive information. Based on the confidence value, a human data steward may manually check the sensitive information 460 and accept or reject if this actually is sensitive information that needs to be redacted.

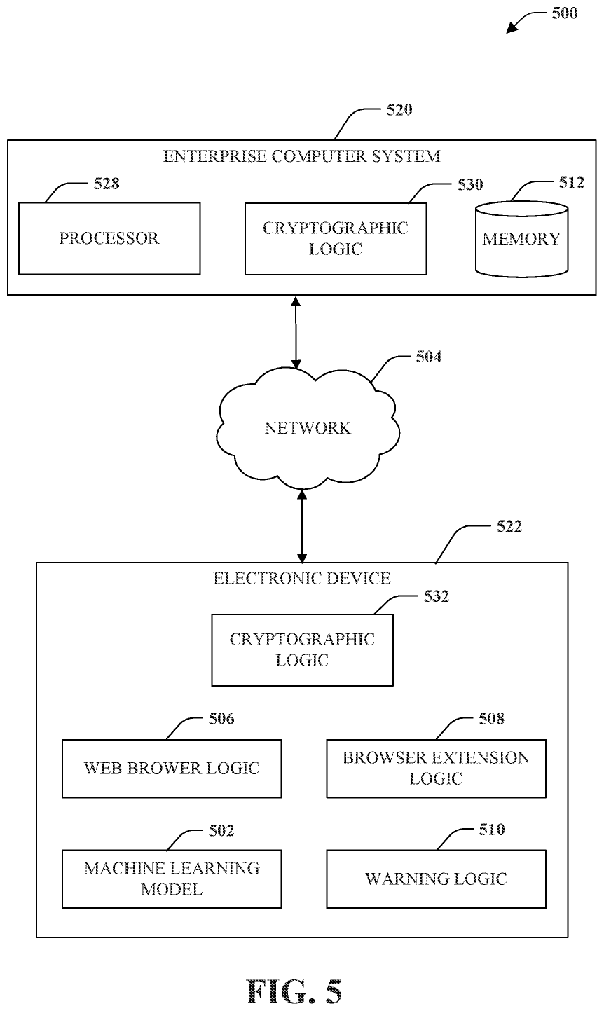

FIG. 5 illustrates another example system 500 for protecting sensitive information entered into an electronic form, website, an electronic device, or the like. The example system 500 includes an enterprise computer system 520, a network 504, and an electronic device 522.

The network 504 allows the enterprise computer system 520 and the electronic device 522 to communicate with each other. The network 504 may include portions of a local area network such as an Ethernet, portions of a wide area network such as the Internet, and may be a wired, optical, or wireless network. The network 504 may include other components and software as understood by those of ordinary skill in the art.

The enterprise computer system 520 includes a processor 528, cryptographic logic 530, and a memory 512. The processor 528 may be implemented with solid state devices such as transistors to create a processor that implements functions that one of ordinary skill in the art will appreciate are executed in silicon or other materials. Furthermore, the processor 528 may be implemented with a general-purpose processor, a digital signal processor (DSP), an application-specific integrated circuit (ASIC), a field-programmable gate array (FPGA), or another programmable logic device, discrete gates or transistor logics, discrete hardware components, or any combination thereof designed to perform the functions described herein.

The memory 512 can be any suitable device capable of storing and permitting the retrieval of data. In one aspect, the memory 512 is capable of storing sensitive information input to an electronic form, a website, software, or in another way. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The electronic device 522 includes a cryptographic logic 532, a web browser logic 506, a machine learning model 502, a browser extension logic 508, and a warning logic 510. The cryptographic logic 532, the web browser logic 506, the machine learning model 502, the browser extension logic 508, and the warning logic 510 may in some instances be implemented in silicon, an FPGA, another solid state device, and/or software.

In general, and similar to what was mentioned above, the electronic device 522 uses the web browser logic 506 to provide for a web browser to be displayed on a display device of the electronic device 522. The web browser logic 506 may further allow the user to access and display a web-based electronic document through the web browser. The web browser logic 506 may further provide for the user to enter data including sensitive information into the electronic document.

Once the electronic document is displayed, the browser extension logic 508 may activate to monitor data including sensitive information being entered into the electronic document. Alternatively, the browser extension logic 508 may active the machine learning model 502 to monitor data including sensitive information being entered into the electronic document. If the browser extension logic 508 detects sensitive information being entered into the electronic document as the browser extension logic 508 is monitoring the electronic document, the browser extension logic 508 may provide the sensitive information and associated data to the machine learning model 502 to be sure the sensitive information is entered correctly into the electronic form.

The machine learning model 502 checks the sensitive information and its associated data (e.g., data on both sides of the sensitive data) to be sure the sensitive information is entered correctly. The machine learning model 502 uses this information and performs a regular expression analysis of the sensitive information to determine if the sensitive information was entered correctly. In one example, the machine learning model 502 may consider context in free-form notes (i.e., unstructured data) to reduce false positives that could happen if using detection through regular expression rules/logic.

When the machine learning model 502 detects that sensitive information has been entered incorrectly, that information is passed to the warning logic 510. The warning logic 510 uses this information to request that the user (or agent) rectify the sensitive information that was incorrectly entered. The request may be a text box that pops up near where the sensitive information was incorrectly entered, explaining why the information is incorrectly entered and how to correctly re-enter that sensitive information. Alternatively, the warning logic 510 may invoke a chat box to pop up and guide the user as to how to correctly enter the sensitive information. In some configurations, the warning logic 510 may prevent the entering of any further data until a current sensitive information entry is corrected.

In some configurations, the warning logic 510 may provide a way for the user or customer agent to override a machine learning model determination that sensitive information has been improperly entered into an electronic form. When this occurs, this override information may be provided to the machine learning model 502 so that the machine learning model 502 may be trained on this information to allow the machine learning model 502 to make better future predictions of sensitive information being improperly entered. Providing feedback leverages human input in the browser to inform the machine learning model 502 for reducing false positives in the future.

Cryptographic logic 530 and cryptographic logic 532 in the enterprise computer system 520 and the electronic device 522, respectively, allow the enterprise computer system 520 and the electronic device 522 to send encrypted data including sensitive information and personally identifiable information (PII) between them. Cryptographic logic 530 and cryptographic logic 532 are operable to produce encrypted sensitive information by way of an encryption algorithm or function. An encryption algorithm is subsequently executed to produce an encrypted value representative of the encoded sensitive information.

Stated differently, the original plaintext of the combination of encoded sensitive information is encoded into an alternate cipher text form. For example, the Advanced Encryption Standards (AES), Data Encryption Standard (DES), or another suitable encryption standard or algorithm may be used. In one instance, symmetric-key encryption can be employed in which a single key both encrypts and decrypts data. The key can be saved locally or otherwise made accessible by cryptographic logic 530 and cryptographic logic 532. Of course, an asymmetric-key encryption can also be employed in which different keys are used to encrypt and decrypt data. For example, a public key for a destination downstream function can be utilized to encrypt the data. In this way, the data can be decrypted downstream at a user device, as mentioned earlier, utilizing a corresponding private key of a function to decrypt the data. Alternatively, a downstream function could use its public key to encrypt known data.

The example system 500 may provide an additional level of security to the encoded data by digitally signing the encrypted sensitive information. Digital signatures employ asymmetric cryptography. In many instances, digital signatures provide a layer of validation and security to messages (i.e., sensitive information) sent through a non-secure channel. Properly implemented, a digital signature gives the receiver reason to believe the message was sent by the claimed sender.

Digital signature schemes, in the sense used here, are cryptographically based, and must be implemented properly to be effective. Digital signatures can also provide non-repudiation, meaning that the signer cannot successfully claim they did not sign a message, while also claiming their private key remains secret. In one aspect, some non-repudiation schemes offer a timestamp for the digital signature, so that even if the private key is exposed, the signature is valid.

Digitally signed messages may be anything representable as a bit-string such as encrypted sensitive information. Cryptographic logic 530 and cryptographic logic 532 may use signature algorithms such as RSA (Rivest-Shamir-Adleman), which is a public-key cryptosystem that is widely used for secure data transmission. Alternatively, the Digital Signature Algorithm (DSA), a Federal Information Processing Standard for digital signatures, based on the mathematical concept of modular exponentiation and the discrete logarithm problem may be used. Other instances of the signature logic may use other suitable signature algorithms and functions.

In another situation, the electronic device 522 executes, on a processor, instructions that cause the processor to perform operations for finding sensitive information. The operations include detecting, with a browser extension associated with a web browser, a user entering information associated with the user into an electronic form. The operations further include monitoring, with the browser extension, the user entering sensitive information into the electronic form. When the instructions detect that the user has entered sensitive information incorrectly, a warning is provided via the browser extension to the user that sensitive information has been incorrectly entered. Instructions are then displayed on how incorrectly entered sensitive information is to be corrected. The instructions correct the incorrectly entered sensitive information based on a response from the user before the sensitive information propagates beyond the electronic form.

The aforementioned systems, architectures, platforms, environments, or the like have been described with respect to interaction between several logics and components. It should be appreciated that such systems and components can include those logics and/or components or sub-components and/or sub-logics specified therein, some of the specified components or logics or sub-components or sub-logics, and/or additional components or logics. Sub-components could also be implemented as components or logics communicatively coupled to other components or logics rather than included within parent components. Further yet, one or more components or logics and/or sub-components or sub-logics may be combined into a single component or logic to provide aggregate functionality. Communication between systems, components or logics and/or sub-components or sub-logics can be accomplished following either a push and/or pull control model. The components or logics may also interact with one or more other components not specifically described herein for the sake of brevity but known by those of skill in the art.

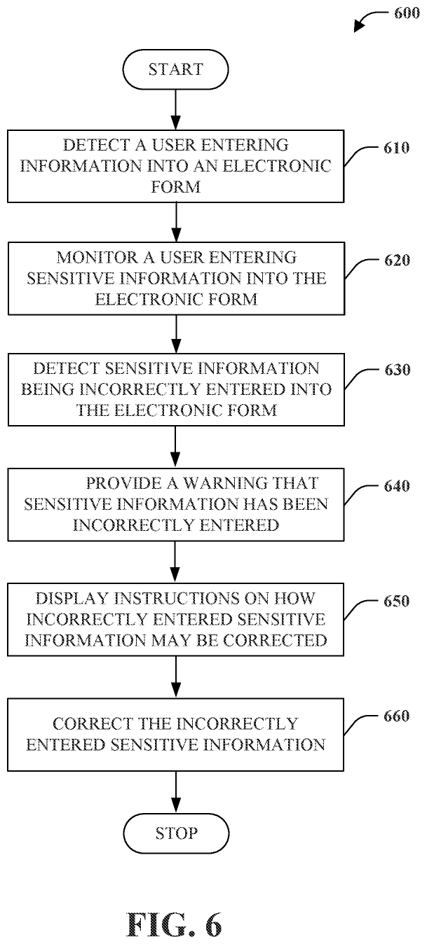

In view of the example systems described above, methods that may be implemented in accordance with the disclosed subject matter will be better appreciated with reference to flow chart diagrams of FIGS. 6-8. While for purposes of simplicity of explanation, the methods are shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 6, a method 600 of sensitive information protection is depicted in accordance with an aspect of this disclosure. The method 600 for protecting sensitive information may execute instructions on a processor that cause the processor to perform operations associated with the method.

At reference number 610, the method 600 detects with a browser extension associated with a web browser, a user entering information associated with the user into an electronic form. The electronic form may be web-based and may be displayed on a web page. The electronic form may be related to a financial institution, a business, a school, or another organization. In some instances, the user is a telephone center agent.

The method 600 monitors, at reference number 620, with the browser extension, the user entering sensitive information into the electronic form. In some configurations, a machine learning model may perform the monitoring.

A detection is made, at reference number 630, as a result of the monitoring, that the user has entered sensitive information incorrectly. In some instances, the method 600 includes detecting sensitive information incorrectly entered in freeform notes.

When the user has entered sensitive information incorrectly, a warning is provided at reference number 640, via the browser extension, to the user that sensitive information has been incorrectly entered. The warning may be provided by a text box near where the sensitive information was incorrectly entered.

Instructions are displayed at reference number 650 on how incorrectly entered sensitive information is to be corrected. In some aspects, the method 600 may display the instructions on how the incorrectly entered sensitive information is to be corrected in a pop-up text box. In some configurations, the operations further include preventing in real-time a transmission of incorrectly entered sensitive information from spreading further downstream from the electronic form.

The incorrectly entered sensitive information is corrected, at reference number 660, based on a response from the user before the sensitive information propagates beyond the electronic form. In some configurations, the operations further comprise preventing the user, by the browser extension, from proceeding to a next electronic form screen until the incorrectly entered sensitive information has been corrected.

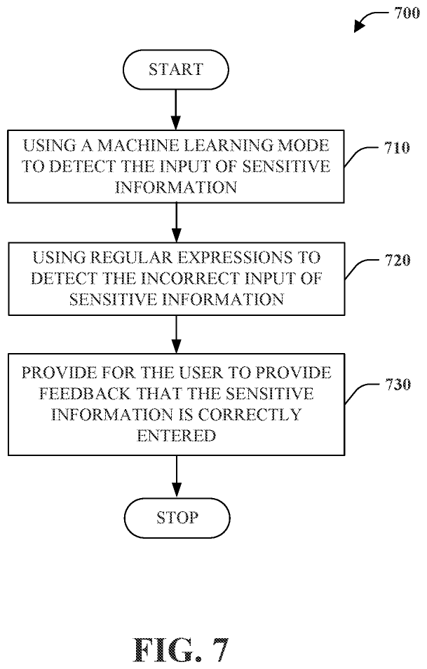

FIG. 7 is another method 700 for protecting sensitive information. This method uses a machine learning model to protect sensitive information. As previously mentioned, the sensitive information may include personally identifiable information (PII). PII may include a person's name, birth date, social security number, credit card number, driver's license number, and the like.

At reference number 710, a machine learning model is invoked to detect if a user is entering sensitive information. Once invoked, the machine learning model may monitor the entering of data and sensitive information into an electronic form.

The machine learning model uses regular expressions, at reference numeral 720, to detect that the sensitive information was incorrectly entered. At reference number 730, the method 700 provides for the user to provide feedback that the sensitive information is correctly entered when the machine learning model indicates that the sensitive information was incorrectly entered. This feedback may be used to further train the machine learning model to improve the model accuracy in the future. In some cases, a human data steward may review the sensitive information and provide feedback to the machine learning model.

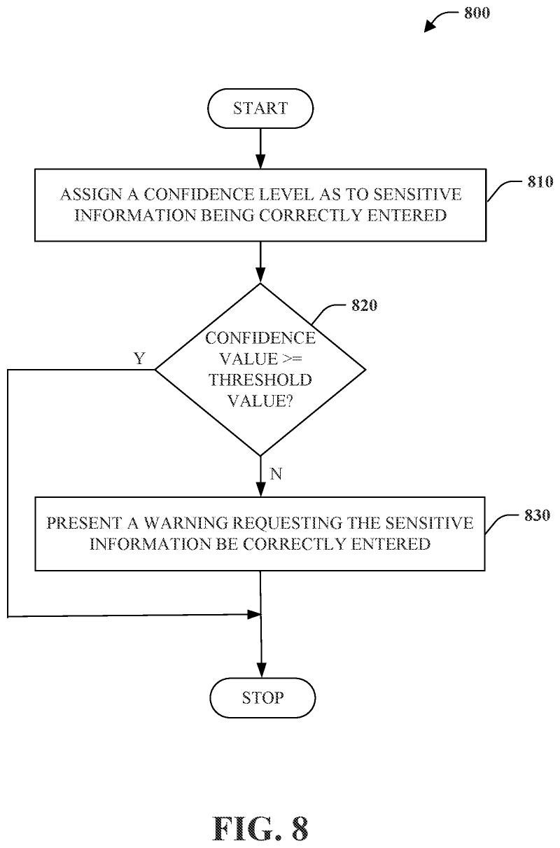

FIG. 8 depicts a method 800 of protecting sensitive information. In general, the sensitive information is entered into an electronic form that is web-based or displayed on an electronic device. Initially, at reference number 810, a confidence level (e.g., risk score) of whether sensitive information has been correctly entered into the electronic form is calculated by a machine learning model.

Based on the confidence level being above or below a threshold level, a determination is made, at reference number 820, if the sensitive information has been entered incorrectly. If the sensitive information has been entered incorrectly, a warning is presented at reference number 830, requesting the user correct the entry of the sensitive information. If the sensitive information has been entered correctly with the confidence value above a threshold level, the flow returns to the start.

As used herein, the terms “component” and “system,” as well as various forms thereof (e.g., components, systems, sub-systems) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

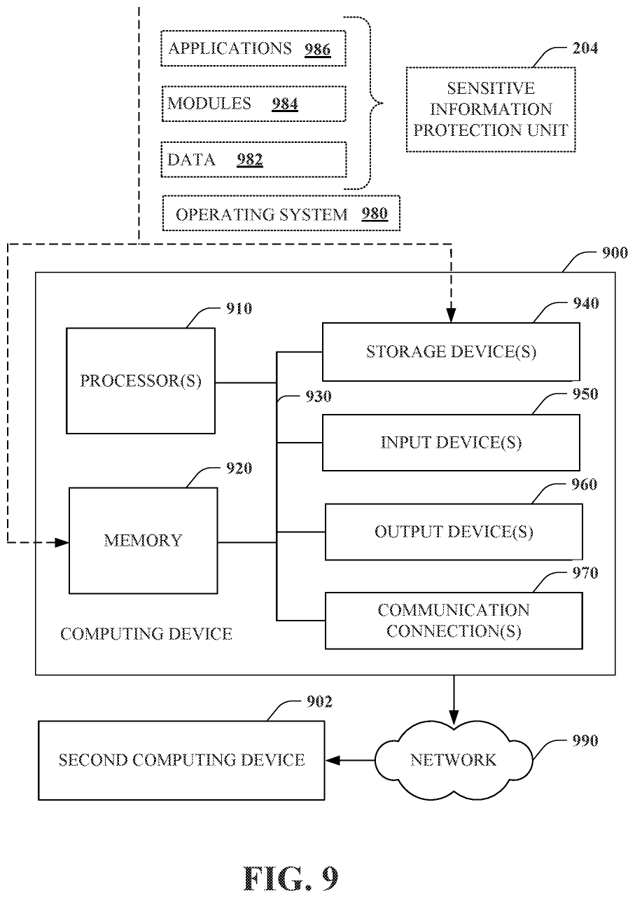

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example, a combination of a DSP and a microprocessor, a plurality of microprocessors, multi-core processors, one or more microprocessors in conjunction with a DSP core, or any other such configuration. In one configuration, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the sensitive information protection system 204 can be, or form part of, the application 986, and include one or more program modules 984 and data 982 stored in memory and/or storage device(s) 940 whose functionality can be realized when executed by one or more processor(s) 910.

In accordance with one particular configuration, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on system 204 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In one instance, the computing device 900 can execute a sensitive information protection system 204 for a first function, and the second computing device 902 can execute a sensitive information protection system 204 for a second function in a distributed processing environment. Further, the second computing device can provide a network-accessible service that stores source code, and encryption keys, among other things that can be employed by the sensitive information protection system 204 executing on the computing device 900.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to memory that includes instructions that, when executed by a processor, cause the processor to:
detect, with a browser extension of a web browser, a user entering information associated with the user into an electronic form;
monitor, with the browser extension, the user entering sensitive information into the electronic form;
detect that the user incorrectly entered the sensitive information;
provide, through the browser extension, a warning to the user that sensitive information has been entered incorrectly;
display instructions on how to correct the incorrectly entered sensitive data; and
correct the incorrectly entered sensitive information based on a response from the user before the sensitive information propagates beyond the electronic form.

2. The system of claim 1, wherein the instructions further cause the processor to invoke a machine learning model to detect that the user has incorrectly entered the sensitive information.

3. The system of claim 2, wherein the instructions further cause the processor to detect that the user incorrectly entered sensitive information when a likelihood predicted by the machine learning model satisfies a predetermined threshold.

4. The system of claim 2, wherein the instructions further cause the processor to invoke the machine learning model to detect that the user has incorrectly entered the sensitive information base on context surrounding the sensitive information.

5. The system of claim 4, wherein the context is included in a free-form notes field.

6. The system of claim 1, wherein the instructions further cause the processor to detect that the user has incorrectly entered the sensitive information based on pattern matching with a regular expression.

7. The system of claim 1, wherein the instructions further cause the processor to prevent the user, by the browser extension, from proceeding to a next electronic form screen until the incorrectly entered sensitive information has been corrected.

8. The system of claim 1, wherein the instructions further cause the processor to at least one of remove, encrypt, or obfuscate the incorrectly entered sensitive data to correct the incorrectly entered sensitive data.

9. The system of claim 1, wherein the user is a telephone center agent.

10. A method, comprising:
executing on a processor, instructions that cause the processor to perform operations associated with protecting potentially sensitive information, the operations comprising:
detecting, with a browser extension associated with a web browser, a user entering information associated with the user into an electronic form;
monitoring, with the browser extension, the user entering sensitive information into the electronic form;
detecting that the user incorrectly entered the sensitive information;
providing, through the browser extension, a warning to the user that the sensitive information has been incorrectly entered;
displaying instructions on how to correct the incorrectly entered sensitive information; and
correcting the incorrectly entered sensitive information based on a response from the user before the sensitive information propagates beyond the electronic form.

11. The method of claim 10, the operations further comprising invoking a machine learning model to detect if the user is entering the sensitive information incorrectly.

12. The method of claim 11, further comprising providing a mechanism to receive feedback from a user regarding performance of the machine learning model.

13. The method of claim 10, the operations further comprising detecting the user incorrectly entered sensitive information with one or more regular expressions.

14. The method of claim 10, the operations further comprising preventing the user, by the browser extension, from proceeding to a next electronic form screen until the incorrectly entered sensitive information has been corrected.

15. The method of claim 10, the operations further comprising displaying instructions on how the incorrectly entered sensitive information is to be corrected in a pop-up text box.

16. The method of claim 10, wherein the correcting further comprises at least one of removing, encrypting, or obfuscating the sensitive information.

17. A computer-implemented method, comprising:
detecting, with a browser extension associated with a web browser, a user entering data into an electronic form;
predicting, with a machine learning model, improper entry of sensitive data into an electronic form field;
providing, with the browser extension, a warning to the user that sensitive data has been improperly entered;
displaying instructions on how to address the improperly entered sensitive data; and
correcting the improperly entered sensitive data based on a response from the user before the sensitive data propagates beyond the electronic form.

18. The method of claim 17, further comprising predicting the improper entry of the sensitive data when a confidence score provided by the machine learning model satisfies a predetermined threshold.

19. The method of claim 17, further comprising predicting the improper entry of the sensitive data based on context information surrounding the sensitive data.

20. The method of claim 17, wherein the correcting further comprises at least one of removing, encrypting, or obfuscating the sensitive data.
